(19) United States
(12) Patent Application Publication
(10) Pub. No.: US 2025/0085835 A1
(43) Pub. Date: Mar. 13, 2025

(54) METHOD FOR DISPLAYING SHARING INTERFACE AND ELECTRONIC DEVICE

(71) Applicant: BEIJING DAJIA INTERNET INFORMATION TECHNOLOGY CO., LTD., Beijing (CN)

(72) Inventors: Hongliang YU, Beijing (CN); Jie WANG, Beijing (CN); Tingting ZHANG, Beijing (CN)

(21) Appl. No.: 18/430,379

(22) Filed: Feb. 1, 2024

(30) Foreign Application Priority Data
Sep. 12, 2023 (CN) 202311176595.1

(51) Int. Cl. G06F 3/0484; G06F 3/0482; G06F 9/451

(52) U.S. Cl. CPC G06F 3/0484; G06F 3/0482; G06F 9/451

(57) ABSTRACT

Provided is a method for displaying a sharing interface. The method is performed by an electronic device and includes: displaying, in response to an information share operation of a user account for information, account information of a first user account and account information of a second user account in an account sharing list in an information sharing interface. The first user account is a user account followed by the user account, and the second user account is a user account that has a target association relationship with the user account and is not followed by the user account.

### CROSS-REFERENCE TO RELATED APPLICATION

This disclosure is based on and claims priority to Chinese Patent Application No. 202311176595.1, filed on Sep. 12, 2023, the disclosure of which is herein incorporated by reference in its entirety.

### TECHNICAL FIELD

The present disclosure relates to the technical field of computers, and in particular, relates to a method for displaying a sharing interface and an electronic device.

### BACKGROUND

With the development of computer technologies, an information sharing technology appears, which can be achieved through an information sharing interface. For example, a user of a video website clicks a share button for a video to display a sharing list, and video sharing is achieved by clicking user account information of a user in the sharing list.

### SUMMARY

The present disclosure provides a method for displaying a sharing interface and an electronic device. The technical solutions of the present disclosure are as follows.

According to some embodiments of the present disclosure, a method for displaying a sharing interface is provided. The method is performed by an electronic device and includes: displaying, in response to an information share operation of a user account for information, account information of a first user account and account information of a second user account in an account sharing list in an information sharing interface, wherein the first user account is a user account followed by the user account, and the second user account is a user account that has a target association relationship with the user account and is not followed by the user account.

According to some embodiments of the present disclosure, an electronic device for displaying a sharing interface is provided. The electronic device includes a processor and a memory configured to store an instruction executable by the processor, wherein the processor is configured to execute the instruction to perform the following process: displaying, in response to an information share operation of a user account for information, account information of a first user account and account information of a second user account in an account sharing list in an information sharing interface, wherein the first user account is a user account followed by the user account, and the second user account is a user account that has a target association relationship with the user account and is not followed by the user account.

According to some embodiments of the present disclosure, a non-transitory computer-readable storage medium is provided. An instruction in the non-transitory computer-readable storage medium, when executed by a processor of an electronic device, causes the electronic device to perform the following process: displaying, in response to an information share operation of a user account for information, account information of a first user account and account information of a second user account in an account sharing list in an information sharing interface, wherein the first user account is a user account followed by the user account, and the second user account is a user account that has a target association relationship with the user account and is not followed by the user account.

### BRIEF DESCRIPTION OF THE DRAWINGS

FIG. 1 is a flowchart of a method for displaying a sharing interface according to some embodiments of the present disclosure;

FIG. 2 is a flowchart of sharing to-be-shared information to a target second user account according to some embodiments of the present disclosure;

FIG. 3 is a diagram of an interface of an information sharing interface according to some embodiments of the present disclosure;

FIG. 4 is a diagram of an interface of an information interaction interface according to some embodiments of the present disclosure;

FIG. 5 is a diagram of another interface of an information sharing interface according to some embodiments of the present disclosure;

FIG. 6 is a diagram of another interface of an information sharing interface according to some embodiments of the present disclosure;

FIG. 7 is a diagram of another interface of an information sharing interface according to some embodiments of the present disclosure;

FIG. 8 is a diagram of another interface of an information sharing interface according to some embodiments of the present disclosure;

FIG. 9 is a diagram of another interface of an information sharing interface according to some embodiments of the present disclosure;

FIG. 10 is a block diagram of an apparatus for displaying a sharing interface according to some embodiments of the present disclosure;

FIG. 11 is a block diagram of an electronic device according to some embodiments of the present disclosure.

### DETAILED DESCRIPTION

It should be noted that user information (including but not limited to user device information, user personal information, and the like) and data (including but not limited to data for display, data for analysis, and the like) involved in the present disclosure are authorized by a user or fully authorized by all parties, and the acquisition, use, and processing of the relevant data need to comply with relevant laws, regulations, and standards.

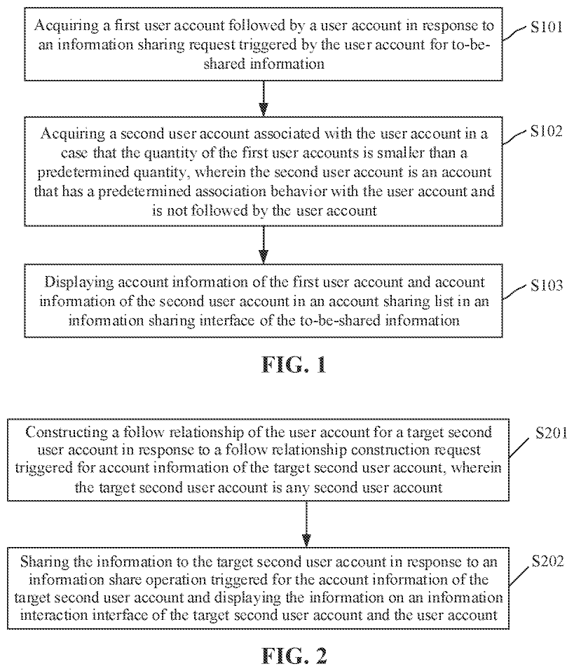

FIG. 1 is a flowchart of a method for displaying a sharing interface according to some embodiments of the present disclosure. As shown in FIG. 1, the method for displaying a sharing interface is performed by an electronic device. Taking the electronic device being a terminal as an example, the terminal is, for example, at least one of a smart phone, a smart watch, a desktop computer, a laptop computer, a virtual reality terminal, an augmented reality terminal, a wireless terminal, a laptop portable computer, and other devices. The method includes the following processes.

In S101, a first user account followed by a user account is acquired in response to an information sharing request triggered by the user account for to-be-shared information.

The to-be-shared information refers to information shared by a user account during information sharing, and the information is video information, picture information, music information, or the like. The information sharing request is triggered by the user account and is configured to share the to-be-shared information to other user account, and the request is triggered by clicking a sharing control by the user account. For example, a video playing interface carries a sharing control for sharing the video to other user account, and the video is shared to other user by clicking the sharing control. The first user account refers to other user account that is followed by the user account. Specifically, when an information sharing request for sharing certain information to other user account is triggered by a certain user account, the terminal responds to the request and acquires other user account followed by the user account as the first user account. Therefore, the user account performs an information share operation for certain information, such that the electronic device acquires the first user account followed by the user account in response to the information share operation.

In S102, in a case that the quantity of the first user account is smaller than a predetermined quantity, a second user account associated with the user account is acquired, wherein the second user account is an account that has a predetermined association behavior with the user account and not followed by the user account.

The predetermined quantity is the predetermined quantity of user accounts or is also referred to as a target quantity. For example, the target quantity is three, which is not limited in the embodiments of the present disclosure. The second user account is an account that previously has an association behavior with the user account (or the second user account has a target association relationship with the user account) and for which the user account has not established a follow relationship (that is, the user account does not follow). For example, the second user account is an account that is previously stored in an address book of the user account and is not followed by the user account, or the second user account is an account that had an interaction behavior with the user account and is not followed by the user account, wherein the interaction behavior is sharing information, giving a like to a post, commenting a post, or the like, or the second user account is a user account that follows the same account as the user account (for example, the user account and the second user account both follow a user account C), and the like, which is not limited in the embodiments of the present disclosure. In some embodiments, the second user accounts having the target association relationship with the user account may be acquired by searching the address book of the user account and analyzing the history behavior data of the user account. For example, based on an address book of the user account, a plurality of candidate user accounts in the address book that have not established a follow relationship with the user account are determined; then based on history behavioral data of the user account, it is determined whether an interaction behavior has occurred between the user account and each of the candidate user accounts. In a case that there is a candidate user account that has had an interaction behavior with the user account, it is determined that this candidate user account has the target association relationship with the user account, and this candidate user account is determined as the second user account. In the embodiments of the present disclosure, in a case that the quantity of first user accounts followed by the user account is small, that is, in the case that the quantity of the first user accounts is smaller than the predetermined quantity, the electronic device acquires an account that has an association relationship with the user account but is not followed by the user account as a second user account. Therefore, the second user account is a user account that has a target association relationship with the user account and is not followed by the user account. In some embodiments, the target association relationship includes at least one of the following: the second user account is a user account in an address book of the user account; the second user account is a user account that interacted with the user account; and the second user account is a user account that follows the same account as the user account. In some embodiments, the electronic device acquires a second user account associated with the user account upon acquiring the first user account, that is, regardless of the quantity of the first user accounts, and the present disclosure does not impose any limitations in this regard. In some embodiments, the electronic device acquires the second user accounts based on the quantity of accounts that can be displayed in the account sharing list and the quantity of the first user accounts. For example, in a case that the electronic device acquires ten first user accounts and the quantity of accounts that can be displayed in the account sharing list is 20, the electronic device acquires ten second user accounts, which is not limited in the embodiments of the present disclosure.

In S103, account information of the first user account and account information of the second user account are displayed in an account sharing list in an information sharing interface.

The information sharing interface is a sharing interface configured to share information to other user accounts. An account sharing list containing multiple account information is displayed on the sharing interface, and the user account can achieve information sharing through the sharing list. In some embodiments, in the case that the quantity of first user accounts that the user account follows is small, the account sharing list not only displays account information of the first user accounts that the user follows, but also displays a second user account that is not followed by the user account but has a target association relationship with the user account, such that account information vacancy in the account sharing list due to a small quantity of users followed can be avoided, thereby improving a resource utilization rate of the account sharing list. In other embodiments, in a case that the quantity of the first user accounts followed by the user account is large, that is, in a case that the quantity of the first user accounts is greater than or equal to the predetermined quantity, only the account information of the first user accounts is displayed.

As can be seen from the processes S101 to S103 described above, the user account performs an information share operation for certain information, such that the electronic device acquires the first user account and the second user account in response to the information share operation, and based on this, account information of the first user account and account information of the second user account are displayed in the account sharing list in the information sharing interface. These processes can also be described as displaying, in response to an information share operation of a user account for information, account information of a first user account and account information of a second user account in an account sharing list in an information sharing interface, wherein the first user account is a user account followed by the user account, and the second user account is a user account that has a target association relationship with the user account and is not followed by the user account. In some embodiments, the account sharing list lists account information of a plurality of the first user accounts and account information of the second user accounts, and the plurality of the second user account are identified such that a user logged in the user account can clearly know which user accounts which he/she has not followed. The identification may be display of a follow control at a position corresponding to the second user account. The appearance of the follow control indicates that the corresponding user account has not been followed and can be followed if the follow control is triggered.

In the method for displaying a sharing interface described above, the first user account followed by the user account is acquired in response to the information sharing request triggered by the user account for to-be-shared information. The second user account associated with the user account is acquired in the case that the quantity of the first user accounts is smaller than the predetermined quantity, wherein the second user account is the user account that has the predetermined association behavior with the user account and is not followed by the user account. The account information of the first user account and the account information of the second user account are displayed in the account sharing list in the information sharing interface of the to-be-shared information. In the related art, the to-be-shared user accounts displayed in a sharing interface are only the user accounts which the sharing user account follows. When a quantity of the user accounts which the sharing user accounts follow are small, the sharing list is short and leaves some empty space not used. According to the present disclosure, in the case that the quantity of the first user accounts followed by the user account is smaller than the predetermined quantity, besides the account information of the first user account followed by the user account, the account information of the second user account that is not followed by the user account but has other association behaviors with the user account is also displayed in the account sharing list in the information sharing interface of the user account for the to-be-shared information, such that in a case that the quantity of users followed by the sharing user is small, the account information display vacancy in the sharing list is avoided, thereby improving the resource utilization rate of the sharing list.

In some embodiments, two information sharing modes are involved in the process of sharing information, wherein the information sharing mode refers to a sharing mode for to-be-shared information. The two information sharing modes includes a first sharing mode and a second sharing mode, wherein the first sharing mode is a sharing mode that information sharing depends on a follow relationship, and the second sharing mode is a sharing mode that information sharing does not depend on a follow relationship. Information sharing processes under the two information sharing modes are introduced separately, and the following two situations are included. The two situations include a first situation and a second situation.

The first situation: in a case that the information sharing mode is characterized by a first sharing mode that information sharing depends on construction of a follow relationship in advance, that is, in a case that the information sharing mode is the first sharing mode, as shown in FIG. 2, upon the S103, the method further includes processes S201 and S202.

In S201, constructing a follow relationship of the user account for a target second user account in response to a follow relationship construction request triggered for account information of the target second user account, wherein the target second user account is any second user account.

The information sharing mode refers to a sharing mode for to-be-shared information, and the first sharing mode is a sharing mode depending on construction of a follow relationship in advance. Under the first sharing mode, the user account needs to construct a follow relationship with the second user account in advance, that is, the user account needs to follow the second user account in advance to share information to the second user account. Taking the target second user account as an example, in the case that the current information sharing mode is the first sharing mode, the user account follows in advance the target second user account to which the information needs to be shared, that is, a follow relationship construction request for constructing a follow relationship with the target second user account is triggered, the request is triggered by performing a trigger operation on account information of the target second user account, and the electronic device responds to the request to construct the follow relationship of the user account for the target second user account, that is, the following of the user account for the target second user account is completed. Therefore, the user account performs the follow operation for the target second user account, such that the electronic device constructs the follow relationship of the user account for the target second user account in response to a follow operation, wherein this follow relationship is referred to as a first follow relationship, and the first follow relationship is that the target second user account is followed by the user account, which is also understood as one-way follow of the user account for the target second user account.

In S202, the information is shared to the target second user account in response to an information share operation triggered for account information of the target second user account, and the information is displayed on an information interaction interface of the target second user account and the user account.

The information share operation is an operation triggered by the user account and sharing the information to the target second user account. The information interaction interface is an interface for information interaction between the target second user account and the user account. For example, the information interaction interface is a chat interface of the target second user account and the user account. After the user account completes the following for the target second user account, the user account further triggers an information share operation of sharing the information to the target second user account. For example, after the user account completes the following of the target second user account by performing a trigger operation on account information of the target second user account, the user account performs a trigger operation on the account information of the target second user account again, such that the electronic device shares, in response to the trigger operation, the information to the target second user account and displays the information on the chat interface of the target second user account and the user account. In some embodiments, the displayed account information is configured as a share control. The trigger operation on the account information causes the sharing of the information. In the first sharing mode, the follow control and the share control are configured to be dependent. and the share control is triggerable only after the trigger operation on the follow control is performed. Therefore, the process described above can also be described as sharing, by the electronic device in response to a trigger operation on account information of the target second user account, the information to the target second user account in a case that the first follow relationship has been constructed. In the embodiments of the disclosure, in the case that the information sharing mode is the first sharing mode, the user account first constructs the follow relationship for the target second user account, that is, constructs the first follow relationship, and then achieves information sharing. In this way, user following can be achieved while information is shared, which can improve the diversity of functions of the sharing interface.

In some embodiments, the first user accounts and the second user accounts are identified in the account sharing list. The second user accounts in the account sharing list may be identified by a identifier. For example, a follow control is used as an identifier and displayed at a position corresponding to the account information of a second user account to indicate that the second user account is an account not followed by the user account. It should be appreciated that the account information may be displayed in any appropriate manner to distinguish the first user account and the second user account.

In some embodiments, the account information of the first user account includes an account image of the first user account, and the account information of the second user account includes an account image of the second user account. The account image may be an avatar of the user account. The account image of a first user account and the account image of a second user account are configured as a share control for sharing the information to the first user account and the second user account. In some embodiments, taking the target second user account as an example, a control for constructing a follow relationship, also referred to as a follow control, is displayed on an account image of the target second user account, that is, the follow control is configured to enable following of the target second user account. The follow control and the sharing control are configured to be dependent. The sharing control is enabled only after the follow control is triggered and a first follow relationship has been constructed. The arrangement of the follow control on the account image can indicate the sequence of constructing a follow relationship first and then sharing the information as the follow control is disposed on or above the account image, and the display of the two controls overlaps. The step S201 includes: constructing a follow relationship of the user account for the target second user account in response to a trigger operation on the follow control, that is, constructing a first follow relationship. In this embodiment, the account information of the first user account includes the account image of the first user account, and the account information of the second user account includes the account image of the second user account. For example, the account image is an account avatar, and the control for constructing a follow relationship, that is, the follow control, is displayed on the account avatar of the second user account. In this embodiment, the user performs a trigger operation on the follow control displayed on the avatar of the second user account in the account sharing list to achieve the following of the target second user account by the user account.

Referring to FIG. 3, an information sharing interface of a user account is illustrated. The information sharing interface is an interface displayed on an electronic device in which the user account is logged. As shown in FIG. 3, the information sharing interface 300 includes an account sharing list and an application list for sharing to other applications. The account information includes an account image or an avatar. In the account sharing list, an avatar A corresponding to an account A, an avatar B corresponding to an account B, and an avatar C corresponding to an account C are displayed. In the application list, identifiers “application A”, “application B”, and “application C” of different applications are displayed. The user account has followed the account A but has not followed the account B and the account C, and therefore the account A is the first user account while the account B and the account Care the second user accounts. The controls for constructing the follow relationship, that is, the “follow” controls shown in FIG. 3, are displayed on the avatars of the account B and the account C, and the follow control is not displayed on the avatar A of the account A. In the illustrated embodiment, the second user accounts can be identified by the “follow” control. In this embodiment, the control for constructing the follow relationship is displayed on the account images of the second user accounts, and the following of the target second user account by the user account is achieved by triggering the control. In this way, the efficiency of achieving the following of a user on the sharing interface can be improved.

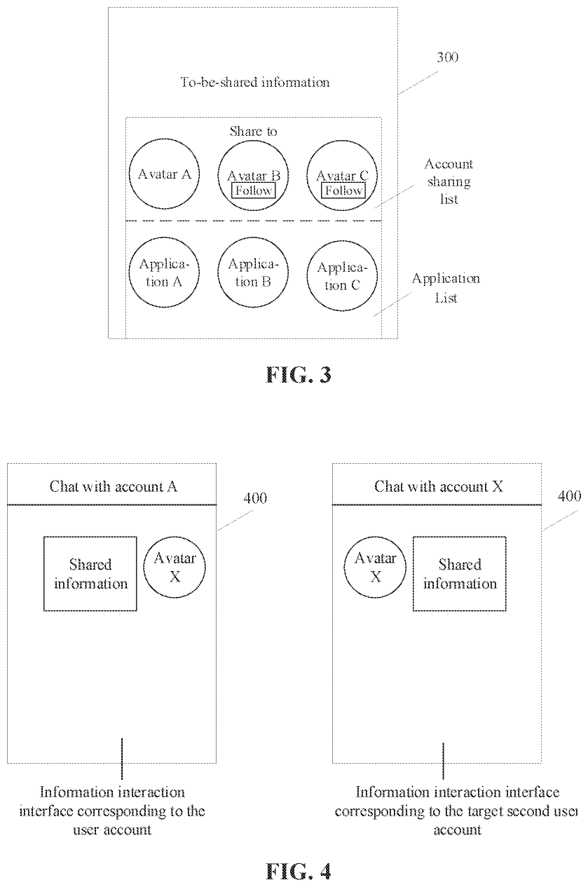

Further, upon constructing the follow relationship of the user account for the target second user account, that is, upon constructing the first follow relationship, the method further includes: canceling the displaying of the follow control on the account image of the target second user account. In some embodiments, S202 further includes: sharing the information to the target second user account in response to a trigger operation on the account image of the target second user account and displaying the information on the information interaction interface of the target second user account and the user account. For example, as shown in FIG. 4, an information interaction interface 400 is a chat interface between a target second user account A and a user account X. An Avatar A is an avatar corresponding to the target second user account A. An avatar X is an avatar corresponding to the user account X. The information interaction interface 400 shown at the left in FIG. 4 is the information interaction interface 400 displayed at a terminal in which the user account X is logged, which shows chat with the target second user account A, and displays shared information shared to the target second user account A. The avatar X of the user account X is displayed at a position corresponding to the shared information. The information interaction interface 400 shown at the right in FIG. 4 is the information interaction interface 400 displayed at a terminal in which the target second user account A is logged, which shows chat with the user account X, and displays the shared information by the user account X. The avatar X is displayed at a position corresponding to the shared information to indicate that the information is shared by the user account X.

In some embodiments, after the following of the target second user account by the user account is completed, the electronic device cancels the displaying of the follow control on the account image of the target second user account and shares the information to the target second user account by performing a trigger operation on the account image of the target second user account again, for example, clicking on the avatar of the target second user account, and then the information can be displayed on the information interaction interface of the target second user account and the user account. For example, the information is displayed on a chat interface of the target second user account and the user account.

In addition, after the sharing is completed, a control for sending associated information to the target second user account can be displayed in the information sharing interface, wherein the associated information refers to information related to the shared information. The user account can send information related to the shared information through the control. For example, the information is introduction text information of the shared information, a reason for sharing the shared information, or the like.

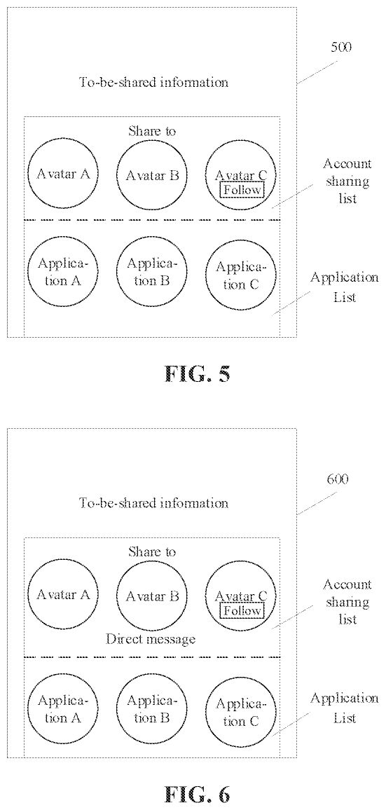

In some embodiments, after the electronic device displays the information sharing interface as shown in FIG. 3, in a case that the user account clicks the “follow” control in the avatar of the account B, the electronic device displays the information sharing interface 500 as shown in FIG. 5. In FIG. 5, the displaying of the “follow” control in the avatar of the account B is canceled. The account B becomes a follow account in the account sharing list, that is, the account B is displayed as a first user account. The user account can share information to the account B by clicking the avatar of the account B. In some embodiments, after the sharing is completed, as shown in FIG. 6, a control for sending associated information of the shared information to the account B, that is, a “direct message” control, is displayed on the information sharing interface 600. By clicking the direct message control, the user account can send the reason for sharing the shared information to the account B.

In the embodiments of the present disclosure, after the user account follows the target second user account, the control for constructing the follow relationship displayed in the account image of the target second user account is canceled, the information is shared to the target second user account by performing the trigger operation on the account image of the target second user account, and then the control for sending associated information of the shared information is displayed in the information sharing interface. In this way, the information sharing efficiency can be further improved.

The second situation: in a case that the information sharing mode is characterized by a second sharing mode that information sharing does not depend on construction of a follow relationship in advance, that is, in a case that the information sharing mode is the second sharing mode, after the S103, the method further includes:

sharing the information to the target second user account in response to a trigger operation on account information of the target second user account, wherein the second sharing mode is a sharing mode that information sharing does not depend on a follow relationship, and the target second user account is any second user account.

The second sharing mode refers to a sharing mode not depending on construction of a follow relationship in advance. Under the second sharing mode, the user account does not need to construct a follow relationship with the second user account in advance, that is, the user account can share information to the second user account without following the second user account in advance. Therefore, under the second sharing mode, the user account directly performs a trigger operation on account information of the target second user account and shares the information to the target second user account. The information is displayed on the information interaction interface of the target second user account and the user account. The user account does not need to follow the target second user account in advance.

In some embodiments, the account information of the first user account includes the account image of the first user account, and the account information of the second user account includes the account image of the second user account. In this case, taking the target second user account as an example, the electronic device shares the information to the target second user account in response to a trigger operation on the account image of the target second user account, and the electronic device displays the information on the information interaction interface of the target second user account and the user account. That is, in the case that the information sharing mode is the second sharing mode, the user account can directly perform a trigger operation on the account image of the target second user account to achieve information sharing, and the sharing is performed without following the target second user account in advance. In this way, the diversity of information sharing can be improved.

Further, the control for constructing the follow relationship of the user account for the second user account, that is, a follow control, is displayed in the account sharing list. In addition to enable the construction of the follow relationship, the follow control disposed at a position corresponding account information of a user account can identify the user account as a second user account. In some embodiments, upon sharing the information to the target second user account, the method further includes: constructing a follow relationship of the user account for the target second user account in response to a trigger operation on the follow control displayed in the account sharing list and canceling the displaying of the follow control in the account sharing list. That is, the first follow relationship is constructed in response to the trigger operation on the follow control, wherein the first follow relationship is that the target second user account is followed by the user account. It is noted that the trigger operation for the follow control may be performed before the information is shared to the target second user account, or after the information is shared to the target second user account, which is not limited in the present disclosure.

In the embodiments of the present disclosure, the follow control for constructing the follow relationship of the user account for the target second user account is also displayed in the account sharing list. For example, the follow control is displayed below the account image of the target second user account, or the follow control is displayed at a place adjacent to the account image of the target second user account such that the account image and the target second user account are displayed separately. In some embodiments, the account image of each user account in the account sharing list is configured to be a share control such that a trigger operation on the account image enables sharing of the information. The account image (i.e., the share control) and the follow control are configured to be independent controls such that the user account can perform the trigger operations in a sequence of triggering the sharing control first and then triggering the follow control, or in a sequence of triggering the follow control first and then triggering the sharing control. In some scenarios, the user account can perform a trigger operation on the follow control below the account avatar or adjacent to the account avatar, such as clicking the follow control below the account avatar or adjacent to the avatar, to construct the follow relationship of the user account for the target second user account. After the user account follows the target second user account, the displaying of the follow control in the account sharing list is canceled. Then, a control for sending associated information of the shared information to the target second user account is further displayed, and the user account performs a trigger operation on the control to send the associated information. For example, the associated information includes a reason for information sharing and the like.

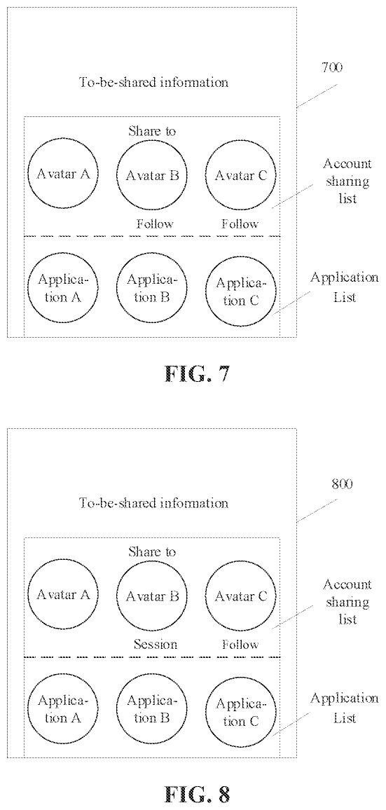

In some embodiments, the information sharing interface 700 is as shown in FIG. 7. The information sharing interface 700 includes an account sharing list and an application list for sharing to other applications. In the account sharing list, an avatar A corresponding to an account A, an avatar B corresponding to an account B, and an avatar C corresponding to an account C are displayed. In the application list, identifiers “application A”, “application B”, and “application C” of different applications are displayed. The user account has followed the account A but has not followed the account B and the account C, that is, the account A is the first user account while the account B and the account C are the second user accounts. The control for constructing a follow relationship (that is, the “follow” control) is displayed below the avatars of the account B and the account C, and the “follow” control is not displayed below the avatar A of the account A. The “follow” control is also used as an identifier to distinguish the first user account and the second user account. It should be noted that the position of the follow control in the account sharing list is not limited in the present disclosure, and it may be disposed a position adjacent to account information of the second user account, and displayed separately from the account information of the second user account. In one scenario, the user account shares the information to the account B by clicking the avatar of the account B, and after the information is shared, the user account can achieve the following of the account B by clicking the “follow” control below the avatar of the account B. After the following of the account B is completed, the information sharing interface 800 is as shown in FIG. 8. As shown in FIG. 8, the displaying of the “follow” control below the avatar of the account B is canceled, and a control for sending associated information of the shared information to the account B, that is, a “session” control, is displayed. By clicking the session control, the user account is able to send the reason for sharing the shared information to the account B.

In the embodiments of the present disclosure, as one scenario, by displaying the control for constructing the follow relationship in the account sharing list, the user account is able to perform the trigger operation on the control to construct the follow relationship for the target second user account (that is, the first follow relationship), and after the first follow relationship is constructed, the displaying of the control is canceled, such that the efficiency of following a user account in the information sharing interface can be improved.

In some embodiments, as another scenario, in the case that the information sharing mode is the second sharing mode, the control for constructing the follow relationship of the user account for the second user account (that is, the follow control) is displayed in the account sharing list separately from the account information of the second user account; upon displaying the account information of the first user account and the account information of the second user account, the method further includes: constructing a follow relationship of the user account for a target second user account in response to a trigger operation on the follow control displayed in the account sharing list; and canceling the displaying of the follow control in the account sharing list.

In the embodiments of the present disclosure, in the case that the information sharing mode is the second sharing mode in which information sharing does not depend the constructing the following relationship in advance, the user account is still able to construct the follow relationship for the target second user account first and then performs information sharing, and the manner of constructing the follow relationship for the target second user account is triggering the follow control displayed in the account sharing list, such as triggering the follow control displayed below the account avatar for constructing the follow relationship.

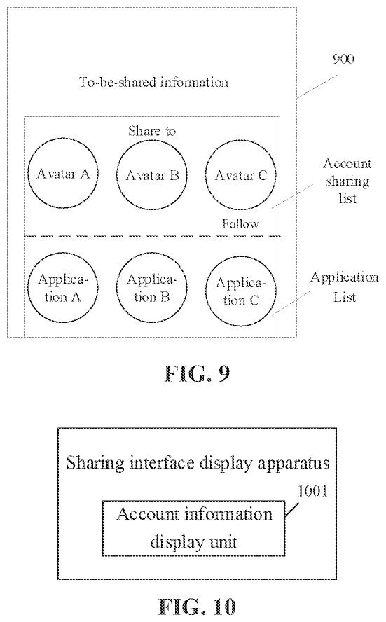

In some embodiments, as shown in FIG. 7, in the account sharing list of the information sharing interface 700, a “follow” control is displayed below the avatars of the second user accounts that are not followed by the user account. In the case that the user account wants to follow the target second user account, such as the account B, the user account can follow the account B by clicking the “follow” control below the avatar of the account B, and then the displaying of the “follow” control below the avatar of the account B is canceled in the account sharing list, as shown in the information sharing interface 900 in FIG. 9. In the embodiments of the present disclosure, in the case that the sharing mode is the second sharing mode, in the information sharing interface, the target second user account can be directly followed by triggering the follow control without sharing the information to the target second user account in advance, such that the efficiency of following a user account in the information sharing interface can be further improved.

Further, the account information of the first user account includes the account image of the first user account, and the account information of the second user account includes the account image of the second user account. In this case, upon canceling the displaying of the follow control in the account sharing list, the method further includes: sharing the information to the target second user account in response to a trigger operation on the account image of the target second user account, and displaying the information on an information interaction interface of the target second user account and the user account.

That is, after the following of the target second user account is completed, a trigger operation is performed for the account image of the target second user account. That is, the account avatar of the target second user account is clicked, such that information is shared to the target second user account and displayed on an information interaction interface, such as a chat interface, of the target second user account and the user account.

Then, a session control for sending associated information of the shared information to the target second user account is displayed in the information sharing interface, and the user account performs a trigger operation on the session control to send the associated information. For example, the associated information includes a reason for information sharing and the like.

In the embodiments of the present disclosure, in the second sharing mode, after the following of the target second user account is completed, information sharing is achieved by performing a trigger operation on the account image of the target second user account. In this way, the manner of sharing information is diversified.

In addition, based on the two situations described above, under either the first sharing mode or the second sharing mode, the user account is able to share the information to the target second user account by performing a trigger operation on the account image of the target second user account in the case that the account information of the target second user account includes the account image of the target second user account. In other words, in the embodiments of the present disclosure, the function of achieving quick sharing of information through the account image is applicable to both the first sharing mode and the second sharing mode. In some embodiments, the process of sharing the information through the account image of the target second user account can be described as sharing the information to the target second user account in response to a trigger operation on the account image of the target second user account.

In addition, under either the first sharing mode or the second sharing mode described above, the follow control can be displayed in the account sharing list, and the follow control is configured to enable following of the target second user account. As the follow control is displayed in the account sharing list, it can also be used as an identifier for the second user account in some embodiments, such that the user account can distinguish the first user account and the second user account, and complete following of the target second user account by performing a trigger operation on the follow control. In other words, in the embodiments of the present disclosure, the function of achieving quick following through the follow control is applicable to both the first sharing mode and the second sharing mode. In some embodiments, the process of following the target second user account through the follow control can be described as constructing a first follow relationship in response to a trigger operation on the follow control, wherein the first follow relationship is a follow relationship that the target second user account is followed by the user account.

In some embodiments, the to-be-shared information is shared and then displayed on the information interaction interface of the target second user account and the user account. In other words, the electronic device displays the information on the information interaction interface of the target user account and the user account in the case that the information is shared to the target second user account. In this case, the method further includes: sending prompt information to the target second user account for displaying in the case that the user account has constructed a follow relationship for the target second user account (in other words, in the case that the user account has followed the target second user account), wherein the prompt information prompts the target second user account to construct a follow relationship for the user account, or the prompt information indicates construction of a second follow relationship, wherein the second follow relationship is a follow relationship that the user account is followed by the target second user account. In some embodiments, in the case that the user account has followed the target second user account, prompt information is sent to the target second user account in response to a prompt information send operation triggered by the user account on the information interaction interface, which is not limited in the present disclosure.

In the embodiments of the present disclosure, after the to-be-shared information is shared, the electronic device displays the information on the information interaction interface of the target second user account and the user account. In the case that the user account has constructed the first follow relationship, that is, the user account has followed the target second user account, the user account is able to send, by performing a prompt information send operation on the information interaction interface, the prompt information to the target second user account to prompt the target second user account to construct a follow relationship for the user account, wherein the prompt information is displayed on a session list of the target second user account (that is, the prompt information is displayed on the electronic device logged in with the target second user account). Then, besides the shared information, a follow control configured to enable following of the user account by the target second user account is displayed on the information interaction interface, such as a chat interface, of the target second user account and the user account. The target second user account is able to follow the user account by clicking the follow control, such that mutual following of the user account and the target second user account is achieved.

In this embodiment, after information sharing is completed, in the case that the user account has followed the target second user account, the target second user account is prompted to follow the user account by sending prompt information. In this way, efficiency of mutual following of accounts can be further improved.

In some embodiments, a method for recommending a user account in a sharing list is provided, which allows recommendation of a user account in a sharing scenario and is specifically implemented by the following:

(1) A sharing queue and a recommendation queue are included in a sharing panel:

In a case that the quantity of user accounts in the sharing queue is less than or equal to N (N is a positive integer), for example, N is equal to 20, and the first line of the sharing queue is not completely filled (for example, the first line is able to show 20 user accounts, but ten first user accounts are followed by the user account and the first line is not completely filled), the first line is supplemented with the recommendation queue, wherein the recommendation strategy includes: 1. a user account with which an active/passive sharing via the direct message has occurred and that is not followed is preferentially recommended; 2. an associated user account with which sharing outside the application has occurred and the shared information has been opened is preferentially recommended; meanwhile, to avoid wrong recommendation caused by spreading sharing links under the scene of strangers, if the shared information is opened by more than ten user accounts, these ten user accounts are not recommended, or if the shared information is not opened by a user account for more than three days, this user account is not recommended; 3. a user account whose contact information has been acquired is preferentially recommended, and the like. In some embodiments, the above 10 and 3 are used for illustrative purposes only. For example, if M user accounts open the shared information, the M user accounts are not recommended, wherein M is more than or equal to 1 and less than or equal to N−K, and K is equal to the quantity of the first user accounts that the user account has followed. For another example, if a shared information is not open by a user account for more than S days, this user account is not recommended, wherein S is a positive integer.

(2) Recommended user accounts are added in the avatar column, wherein content shown in the avatar column includes avatars of the user accounts and follow buttons. The following two implementation modes are included:

Mode 1: the sharing can be performed only after following is performed, that is, the first sharing mode:

A user homepage needs to be entered, and the recommendation reason is required for assisting in the decision for following. For the mode 1, a user account can be followed by clicking the follow button at the avatar. The user homepage can be entered by clicking the avatar before following, a direct message button appears after following the user account, wherein the direct message button is configured to sharing information. The recommendation reason is written in an associate text. In some embodiments, for a recommended user account, a recommendation reason for the user account is configured to recommend the user account to be followed. In some embodiments, the location of the associate text is set next to the avatar, such that the reason for recommendation is displayed next to the avatar.

Mode 2: the following process and the sharing process are independent of each other, that is, the second sharing mode. The following two implementations are included:

1. Follow and then Share

Once the follow button of a user account is clicked, the following of the user account is successful, the user account can be in the “sharing queue” next time, and the follow button of the user account disappears;
once the avatar of the user account is clicked, the sharing to the user account is successful, and a session button of the user account appears.
   2. Share and then Follow

Once the avatar of a user account is clicked, the sharing to the user account is successful, and a session button of the user account will not appear;
once the follow button of the user account is clicked, the following of the user account is successful, the follow button of the user account disappears, and meanwhile the session button of the user account appears.

In the embodiments of present disclosure, a user recommendation function is added in the sharing scenario, such that objects to which sharing can be performed are added, and the utilization rate of the sharing list is improved.

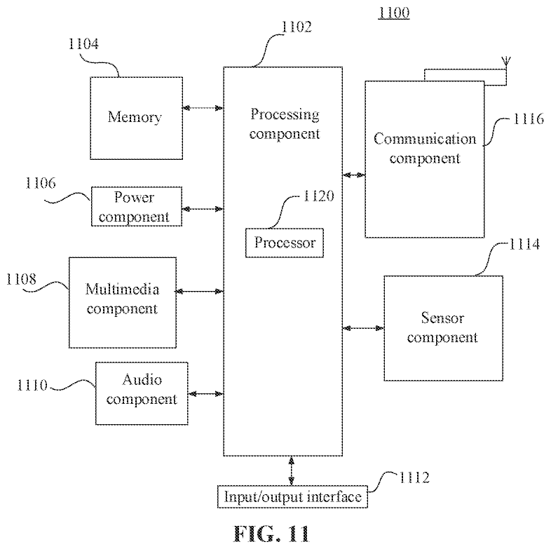

FIG. 10 is a block diagram of an apparatus for displaying a sharing interface according to some embodiments of the present disclosure. Referring to FIG. 10, the apparatus includes an account information display unit 1001.

The account information display unit 1001 is configured to display, in response to an information share operation of a user account for information, account information of a first user account and account information of a second user account in an account sharing list in an information sharing interface, wherein the first user account is a user account followed by the user account, and the second user account is a user account that has a target association relationship with the user account and is not followed by the user account.

In some embodiments, the apparatus further includes a first information sharing unit. The first information sharing unit is configured to construct, in response to a follow operation for a target second user account, a first follow relationship in the case that an information sharing mode is a first sharing mode, and share, in response to a trigger operation on account information of the target second user account, the information to the target second user account in the case that the first follow relationship has been constructed, wherein the target second user account is any second user account, the first sharing mode indicates that information sharing depends on a follow relationship, and the first follow relationship is that the target second user account is followed by the user account.

In some embodiments, the account information of the target second user account includes an account image of the target second user account, and a follow control is displayed on the account image of the target second user account, wherein the follow control is configured to follow the target second user account; and the first information sharing unit is further configured to construct the first follow relationship in response to a trigger operation on the follow control.

In some embodiments, the first information sharing unit is further configured to cancel the displaying of the follow control on the account image of the target second user account.

In some embodiments, the apparatus further includes a second information sharing unit. The second information sharing unit is configured to share, in response to a trigger operation on account information of a target second user account, the information to the target second user account in the case that an information sharing mode is a second sharing mode, wherein the second sharing mode indicates that information sharing does not depend on a follow relationship, and the target second user account is any second user account.

In some embodiments, a follow control is displayed in the account sharing list and the follow control is configured to follow the target second user account. The apparatus further includes a follow relationship construction unit, wherein the follow relationship construction unit is configured to construct a first follow relationship in response to a trigger operation on the follow control, wherein the first follow relationship is that the target second user account is followed by the user account.

In some embodiments, the follow relationship construction unit is further configured to cancel the displaying of the follow control in the account sharing list.

In some embodiments, account information of a target second user account includes an account image of the target second user account, the target second user account is any second user account, and the apparatus is further configured to share the information to the target second user account in response to a trigger operation on the account image of the target second user account.

In some embodiments, a follow control is displayed in the account sharing list and the follow control is configured to follow the target second user account. The apparatus is further configured to construct a first follow relationship in response to a trigger operation on the follow control, wherein the target second user account is any second user account, and the first follow relationship is that the target second user account is followed by the user account.

In some embodiments, the apparatus further includes a prompt information sending unit. The prompt information sending unit is configured to display the information on an information interaction interface of a target second user account and the user account in a case that the information is shared to the target second user account, wherein the target second user account is any second user account; and send prompt information to the target second user account in a case that the target second user account has been followed by the user account, wherein the prompt information indicates construction of a second follow relationship, and the second follow relationship is that the user account is followed by the target second user account.

In some embodiments, the apparatus further includes an acquiring unit, wherein the acquiring unit is configured to acquire the account information of the second user account in a case that the quantity of the first user accounts is smaller than a target quantity.

In some embodiments, the target association relationship includes at least one of:
the second user account is a user account in an address book of the user account;
the second user account is a user account that interacted with the user account; and
the second user account is a user account that follows the same account as the user account.

With regard to the apparatus in the above embodiments, the specific manner in which each unit performs the operation has been described in detail in the method embodiments and will not be described in detail herein.

FIG. 11 is a block diagram of an electronic device 1100 for displaying a sharing interface according to some embodiments of the present disclosure. For example, the electronic device 1100 is a mobile phone, a computer, a digital broadcast terminal, a messaging device, a gamepad, a tablet device, a medical device, a fitness device, a personal digital assistant, or the like.

Referring to FIG. 11, the electronic device 1100 includes one or more of the following components: a processing component 1102, a memory 1104, a power component 1106, a multimedia component 1108, an audio component 1110, an input/output (I/O) interface 1112, a sensor component 1114 and a communication component 1116.

The processing component 1102 generally controls overall operations of the electronic device 1100, such as operations associated with display, telephone calls, data communications, camera operations, and recording operations. The processing component 1102 includes one or more processors 1120 to execute instructions to perform all or some of the processes of the method described above. Moreover, the processing component 1102 includes one or more modules that facilitate the interactions between the processing component 1102 and other components. For example, the processing component 1102 includes a multimedia module to facilitate the interaction between the multimedia component 1108 and the processing component 1102.

The memory 1104 is configured to store various types of data to support the operations on the electronic device 1100. Examples of such data include instructions for any application or method operating on the electronic device 1100, contact data, phonebook data, messages, pictures, videos, and the like. The memory 1104 is implemented by any type or combination of volatile or non-volatile storage devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, an optical disk, or a graphene memory.

The power component 1106 provides power for the various components of the electronic device 1100. The power components 1106 includes a power management system, one or more power supplies, and other components associated with generating, managing, and distributing power for the electronic device 1100.

The multimedia component 1108 includes a screen providing an output interface between the electronic device 1100 and a user. In some embodiments, the screen includes a liquid crystal display (LCD) and a touch panel (TP). In the case that the screen includes a touch panel, the screen can be implemented as a touch screen to receive an input signal from a user. The touch panel includes one or more touch sensors to sense touch, slides, and gestures on the touch panel. The touch sensors not only sense the boundary of a touch or slide action, but also detect the duration and pressure associated with the touch or slide operation. In some embodiments, the multimedia component 1108 includes a front camera and/or a rear camera. The front camera and/or the rear camera receive external multimedia data in a case that the electronic device 1100 is in an operation mode, such as a shooting mode or a video mode. Each of the front camera and the rear camera is a fixed optical lens system or has a focal length and an optical zoom capability.

The audio component 1110 is configured to output and/or input audio signals. For example, the audio component 1110 includes a microphone (MIC). The microphone is configured to receive external audio signals in a case that the electronic device 1100 is in an operation mode, such as a call mode, a recording mode, and a voice recognition mode. The received audio signals are further stored in the memory 1104 or transmitted via the communication component 1116. In some embodiments, the audio component 1110 further includes a speaker configured to output audio signals.

The I/O interface 1112 provides an interface between the processing component 1102 and a peripheral interface module, wherein the peripheral interface module is a keyboard, a click wheel, a button, or the like. The buttons include, but are not limited to: a homepage button, a volume button, a start button and a lock button.

The sensor component 1114 includes one or more sensors, wherein the one or more sensors are configured to provide various aspects of state evaluation for the electronic device 1100. For example, the sensor component 1114 detects an open/closed state of the electronic device 1100, and the relative positioning of components, for example, the components are a display and a keypad of the electronic device 1100. The sensor component 1114 further detects a change in position of the electronic device 1100 or components of the electronic device 1100, the presence or absence of user contact with the electronic device 1100, orientation or acceleration/deceleration of the device 1100, and a change in temperature of the electronic device 1100. In some embodiments, the sensor component 1114 includes a proximity sensor, wherein the proximity sensor is configured to detect the presence of nearby objects in the absence of any physical contact. The sensor component 1114 further includes a light sensor, such as a complementary metal oxide semiconductor (CMOS) or charge-coupled device (CCD) image sensor, wherein the light sensor is configured to be used in imaging applications. In some embodiments, the sensor component 1114 further includes an acceleration sensor, a gyroscope sensor, a magnetic sensor, a pressure sensor, or a temperature sensor.

The communication component 1116 is configured to facilitate the communications between the electronic device 1100 and other devices in a wired or wireless manner. The electronic device 1100 is able to access a wireless network based on a communication standard, such as WiFi, an operator network (such as 2G, 3G, 4G, or 5G), or a combination thereof. In some embodiments, the communication component 1116 receives a broadcast signal or broadcast-associated information from an external broadcast management system via a broadcast channel. In some embodiments, the communication component 1116 further includes a near field communication (NFC) module to facilitate the short-range communications. For example, the NFC module is implemented based on radio frequency identification (RFID) technology, infrared data association (IrDA) technology, ultra wideband (UWB) technology, bluetooth (BT) technology, and other technologies.

In some embodiments, the electronic device 1100 is implemented by one or more application specific integrated circuits (ASICs), digital signal processors (DSPs), digital signal processing devices (DSPDs), programmable logic devices (PLDs), field-programmable gate arrays (FPGAs), controllers, micro-controllers, microprocessors, or other electronic elements to perform the method for displaying a sharing interface described above.

In embodiments of the present disclosure, an electronic device for displaying a sharing interface is provided. The electronic device includes a processor and a memory configured to store an instruction executable by the processor, wherein the processor is configured to execute the instruction to perform the method for displaying a sharing interface described above.

In embodiments of the present disclosure, a non-transitory computer-readable storage medium is provided. An instruction in the non-transitory computer-readable storage medium, when executed by a processor of an electronic device, causes the electronic device to implement the method for displaying a sharing interface described above. In some embodiments, the non-volatile computer-readable storage medium is the memory 1104 storing the instruction, and the instruction, when executed by the processor 1120 of the electronic device 1100, causes the electronic device to perform the method described above. For example, the non-volatile computer-readable storage medium is ROM, random-access memory (RAM), CD-ROM, magnetic tape, floppy disk, optical data storage device, or the like.

In embodiments of the present disclosure, a computer program product including an instruction is provided. The instruction, when executed by the processor 1120 of the electronic device 1100, causes the electronic device to perform the method for displaying a sharing interface described above.

All the embodiments of the present disclosure can be implemented alone or in combination with other embodiments, which are all considered to be within the protection scope of the present disclosure as claimed.

What is claimed is:

1. A method for displaying a sharing interface, performed by an electronic device, comprising:
displaying, in response to an information share operation of a user account for information, account information of a first user account and account information of a second user account in an account sharing list in an information sharing interface, wherein the user account is logged into the electronic device;
wherein the first user account is a user account followed by the user account, and the second user account is a user account that has a target association relationship with the user account and is not followed by the user account, and wherein the second user account is identified in the account sharing list.

2. The method according to claim 1, wherein, in the account sharing list, a follow control is displayed at a position corresponding to the account information of the second user account to identify the second user account, and the following control is configured to follow the second user account; the method further comprising:
constructing a first follow relationship in response to a trigger operation on the follow control corresponding to the second user account, wherein the first follow relationship is a follow relationship that the second user account is followed by the user account; and
sharing, in response to a trigger operation on the account information of the second user account, the information to the second user account.

3. The method according to claim 1, wherein the method further comprising:
constructing, in response to a follow operation for a target second user account, a first follow relationship in a case that an information sharing mode is a first sharing mode, wherein the target second user account is any second user account, the first sharing mode is a sharing mode that information sharing depends on a follow relationship, and the first follow relationship is a follow relationship that the target second user account is followed by the user account; and
sharing, in response to a trigger operation on account information of the target second user account, the information to the target second user account in a case that the first follow relationship has been constructed.

4. The method according to claim 3, wherein the account information of the target second user account comprises an account image of the target second user account, and a follow control is displayed on the account image of the target second user account, wherein the follow control is configured to follow the target second user account, the account image is configured as a share control, and the share control is configured to be enabled after a trigger operation on the follow control is completed; and
said constructing, in response to the follow operation for the target second user account, the first follow relationship comprising:
constructing the first follow relationship in response to the trigger operation on the follow control; and
said sharing, in response to a trigger operation on account information of the target second user account, the information to the target second user account in a case that the first follow relationship has been constructed comprising:
in the case that the constructing the first follow relationship has been completed,
sharing, in response to a trigger operation on the account image of the target second user account, the information to the target second user account.

5. The method according to claim 4, wherein the method further comprises:
canceling the displaying of the follow control on the account image of the target second user account.

6. The method according to claim 1, wherein the method further comprises:
sharing, in response to a trigger operation on account information of a target second user account, the information to the target second user account in a case that an information sharing mode is a second sharing mode, wherein the second sharing mode is a sharing mode that information sharing does not depend on a follow relationship, and the target second user account is any second user account.

7. The method according to claim 6, wherein a follow control is displayed in the account sharing list at a position corresponding the account information of the target second user account, the follow control is configured to follow the target second user account, and to be independent from the trigger operation on the target second user account; and the method further comprises:
constructing a first follow relationship in response to a trigger operation on the follow control, wherein the first follow relationship is a follow relationship that the target second user account is followed by the user account, and said constructing the first follow relationship in response to the trigger operation on the follow control is capable of being performed before or after sharing the information to the target second user account.

8. The method according to claim 7, wherein account information of the target second user account comprises an account image of the target second user account, wherein the account image is configured as a share control, the share control is configured to share information to the target second user account in response to a trigger operation on the share control, and the follow control is displayed adjacent to the account image of the target second user account, and wherein the account image and the following control are independent controls.

9. The method according to claim 1, wherein account information of a target second user account comprises an account image of the target second user account, the target second user account is any second user account, and the account image of the target second user account is configured as a share control, the method further comprises:
sharing the information to the target second user account in response to a trigger operation on the account image of the target second user account.

10. The method according to claim 1, wherein a follow control is displayed in the account sharing list at a position corresponding to the account information of the second user account such that the second user account is identified, and the follow control is configured to follow the second user account, and the method further comprising:
constructing a first follow relationship in response to a trigger operation on the follow control, and the first follow relationship is a follow relationship that the second user account is followed by the user account.

11. The method according to claim 1, wherein the method further comprising:
displaying the information on an information interaction interface of a target second user account and the user account in a case that the information has been shared to the target second user account, wherein the target second user account is any second user account; and
sending prompt information to the target second user account in a case that the target second user account has been followed by the user account, wherein the prompt information indicates construction of a second follow relationship, and the second follow relationship is a followship relationship that the user account is followed by the target second user account.

12. The method according to claim 1, wherein the method further comprises:
acquiring the account information of the second user account in a case that a quantity of the first user accounts is smaller than a target quantity.

13. The method according to claim 1, wherein the target association relationship comprises at least one of:
the second user account is a user account in an address book of the user account;
the second user account is a user account that interacted with the user account; and
the second user account is a user account that follows the same account as the user account.

14. An electronic device for displaying a sharing interface, comprising: a processor and a memory configured to store an instruction executable by the processor, wherein the processor is configured to execute the instruction to perform the following process:
displaying, in response to an information share operation of a user account for information, account information of a first user account and account information of a second user account in an account sharing list in an information sharing interface, wherein the user account is logged into the electronic device;
wherein the first user account is a user account followed by the user account, and the second user account is a user account that has a target association relationship with the user account and is not followed by the user account, and wherein the second user account is identified in the account sharing list.

15. The electronic device according to claim 14, wherein the processor is further configured to execute the instruction to perform the following processes:
constructing, in response to a follow operation for a target second user account, a first follow relationship in a case that an information sharing mode is a first sharing mode, wherein the target second user account is any second user account, the first sharing mode is a sharing mode that information sharing depends on a follow relationship, and the first follow relationship is that the target second user account is followed by the user account; and
sharing, in response to a trigger operation on account information of the target second user account, the information to the target second user account in a case that the first follow relationship has been constructed.

16. The electronic device according to claim 15, wherein the account information of the target second user account comprises an account image of the target second user account, and a follow control is displayed on the account image of the target second user account, and the account image is configured as a share control, wherein the follow control is configured to follow the target second user account, and the share control is configured to be triggerable after a trigger operation on the follow control is performed; and the processor is further configured to execute the instruction to perform the following process:
constructing the first follow relationship in response to the trigger operation on the follow control.

17. The electronic device according to claim 14, wherein the processor is further configured to execute the instruction to perform the following process:
sharing, in response to a trigger operation on account information of a target second user account, the information to the target second user account in a case that an information sharing mode is a second sharing mode, wherein the second sharing mode is a sharing mode that information sharing does not depend on a follow relationship, and the target second user account is any second user account.

18. The electronic device according to claim 17, wherein a follow control is displayed in the account sharing list, the follow control is configured to enable following of the target second user account; and the processor is further configured to execute the instruction to perform the following process:
constructing a first follow relationship in response to a trigger operation on the follow control, wherein the first follow relationship is a follow relationship that the target second user account is followed by the user account.

19. The electronic device according to claim 18, wherein the processor is further configured to execute the instruction to perform the following process:
canceling the displaying of the follow control in the account sharing list.

20. A non-transitory computer-readable storage medium, wherein an instruction in the non-transitory computer-readable storage medium, when executed by a processor of an electronic device, causes the electronic device to perform the following process:
displaying, in response to an information share operation of a user account for information, account information of a first user account and account information of a second user account in an account sharing list in an information sharing interface, wherein the user account is logged into the electronic device;
wherein the first user account is a user account followed by the user account, and the second user account is a user account that has a target association relationship with the user account and is not followed by the user account, and wherein the second user account is identified in the account sharing list.
